(19) United States
(12) Patent Application Publication
(10) Pub. No.: US 2015/0170212 A1
(43) Pub. Date: Jun. 18, 2015

(54) Remotely Connected Digital Messageboard System and Method

(71) Applicant: Peter McGie, Edmonton (CA)

(72) Inventor: Peter McGie, Edmonton (CA)

(21) Appl. No.: 14/630,615

(22) Filed: Feb. 24, 2015

Related U.S. Application Data
(63) Continuation-in-part of application No. 14/179,989, filed on Feb. 13, 2014, now Pat. No. 8,976,009.
Application No. 14/179,989 is a continuation-in-part of application No. 14/133,179, filed on Dec. 18, 2013.
(60) Provisional application No. 61/881,494, filed on Sep. 24, 2013.

(51) Int. Cl. G06Q 30/02; H04W 76/02; H04W 4/00

(52) U.S. Cl. CPC G06Q 30/0267; H04W 4/008; H04W 76/023

(57) ABSTRACT

Provided is a system and method of updating a message or image displayed on an electronic screen via wireless communications device or remote website. Messages are entered into the communications device (an input terminal) or web interface using one or more input methods. Input methods include alphanumeric text input, verbal commands translated into text input, visual content stored on the input device, or written input via the input device. The input is then transmitted as digital data to one or more electronic screens, where the input is then displayed. The input can be modified and edits prior to transmission. Thus, users can update an electronic display remotely. One or more input devices can modify one display, or alternatively one input device can be used to modify multiple displays. Each electronic display is in enabled to wirelessly communicate over a wireless network such as a Wi-Fi, cellular, or Bluetooth network.

### CROSS REFERENCE TO RELATED APPLICATION

This application is a Continuation in Part of U.S. patent application Ser. No. 14/133,179, filed on Dec. 18, 2013 and entitled “Voice Recognizing Digital Messageboard System and Method.” The above-identified patent application is herein incorporated by reference in its entirety to provide continuity of disclosure.

### BACKGROUND OF THE INVENTION

1. Field of the Invention

The present invention relates to digital message display systems, and methods of use. More specifically, it relates to a display screen in communication with a wireless communication device. The wireless communication device has a stored application layer protocol, which facilitates transmission of entered input to one or multiple electronic display screens. A similar application layer is provided in the form of a web interface that is accessible from any Internet accessible computing device. A displayed message or visual content can be rapidly updated by a remote user, thereby increasing efficiency and ease of updating one or more display screens.

Advertising is a key component in the success of any business. In order to find the optimal advertising method for their consumer demographic, businesses will place ads in a variety of locations using many different formats. Examples of common advertisements are billboards, window signs, newspaper ads, website ads, and bumper stickers. As the business grows and learns to better target its consumers, its advertising methods and messages may change. Traditional print media advertisements and even static website ads are unforgiving when it comes to modification. In order to update the ad, the business must commission a new design and have it deployed over the old advertisements. The process can be time consuming and resource intensive.

To solve the problem of switching out advertisements, many marketing providers now employ digital displays in the place of posters and billboards. The digital display contains a storage memory that stores advertising images. These images are displayed for a predetermined time, allowing multiple images to be shown on the same display. When the display needs to be updated to remove an advertisement image or add a new one, the content of the storage media is updated via a network link.

While these digital display systems enable marketing space providers to easily update displayed advertisements, the systems do not make it any easier for an advertising business to update the displayed message. Advertising businesses must still have new images created and submitted to the display maintainer if the business wishes to update their message. This makes it difficult for businesses to advertise flash sales, limited time offers, and other time sensitive messages. The high cost associated with generating and displaying these materials makes it cost prohibitive for many businesses to regularly update their ads.

The present system and method involves advertising signs, as well as signs for general use. The present invention also supports signs for alternative, specific uses not limited to sales or advertising. The present invention comprises a system and a method for dynamically updating one or more digital displays in real-time using one or more wireless input terminals that are remotely operated and mobile in nature. The present invention provides users with the ability to update a digital display via a smartphone, tablet, or similar handheld electronic device forming a remote input terminal that is in wireless connection with the one or more desired displays. The displays may be individually or batched updated using the input terminal.

2. Description of the Prior Art

Devices have been disclosed in the prior art that relate to digital message displays. These include devices that have been patented and published in patent application publications. These devices generally relate to digital message displays. The following is a list of devices deemed most relevant to the present disclosure, which are herein described for the purposes of highlighting and differentiating the unique aspects of the present invention, and further highlighting the drawbacks existing in the prior art.

Digital displays are used throughout the advertising industry to provide a highly visible customizable source of commercial advertising. Large LED display configurations are affixed to billboards, where the resulting message is visible to highway motorists. Small backlight led displays are placed within restrooms, and in dining areas, to facilitate display of local advertisements. Any of these displays can offer rotating advertisements. This is a distinct improvement over traditional paper displays, which only offer one advertisement for viewing at a time.

Small digital displays can be attached to, or integrated into transportation vehicles such as buses and cars. An example of a vehicular display system is disclosed in Brewer, U.S. Patent Application Publication No. 2003/0034934. Brewer teaches a vanity display that secures to an automobile window, and a composition terminal. Text may be entered into the composition terminal for display on the vanity display screen. Though it does disclose the capability of updating the display via an Internet connection, Brewer does not teach updating via a cell phone application, nor does it teach voice recognition capabilities.

Another vehicular display device is disclosed in Marqui, U.S. Patent Application Publication No. 2006/0059745. The Marqui device is a digital display that can be secured to the exterior of an automobile. Multiple input capabilities are provided. Users can update displayed messages via an attached microphone, alphanumeric keypad, or via an Internet connection. Received input is stored on an onboard storage media and displayed on the screen. Unlike the present invention, the Marqui display does not include the use of a cellphone or other wireless device to update the display remotely.

Similarly, Bryan, U.S. patent Application Publication No. 2011/0013109 teaches a solar powered display unit that also provides storage for loose articles. The first side of the display has a screen that shows selected images. Photovoltaic cells are disposed along the front of the display in order to store and convert solar energy. The rear of the device has a white board, gps holder, notepad, and a number of other useful articles. The Bryan device does not disclose the system of the present invention and does not incorporate voice recognition or message updates via a wireless communications device.

The first digital message displays were hardened panels that were affixed to a structural support. Supports such as automobile bumpers, billboard backings, and store windows, were used to bear the load of a cumbersome display housing or panel. In recent years, advertising displays have become increasingly flexible. The use of flexible screens in advertising enables users to conform the advertising to the shape of the underlying support structure. Curved surfaces may be used to support a lightweight display, thereby expanding the scope of potential advertising placement options. An example of a flexible digital display is disclosed in Yuen, U.S. Patent Application Publication No. 2008/0316153.

These prior art devices have several known drawbacks. They do not disclose the capacity to wirelessly update one or more displayed messages via a short-range and/or a long-range wireless network. The present invention provides a display that wirelessly communicates with a communications device to transmit message updates or content without the user physically interacting with the display. Both the system and the disclosed method substantially diverge in elements from the prior art, and consequently it is clear that there is a need in the art for an improvement to existing digital message display systems. In this regard the instant invention substantially fulfills these needs.

### SUMMARY OF THE INVENTION

In view of the foregoing disadvantages inherent in the known types of digital message display systems now present in the prior art, the disclosed invention provides a new wireless display update system and method wherein one or more users can wireless update a displayed messages from one or more wirelessly connected display screens using a short range or long range wireless network. The present invention contemplates various input methods and a wireless network that directly interfaces with a display device or interfaces with the display device using an intermediate remote server.

The invention is a system and method for displaying and updating messages on an electronic display screen. The display screen is a discrete element, separate from the input means. Several methods of input are contemplated, including: textual input using an alphanumeric keypad, voice input with voice recognition translating verbal commands into textual input, digital content in the form of images and video, as well as hand-drawn input using a stylus or touchscreen input on the input terminal.

The input device is one of a handheld electronic device (e.g. a smartphone, tablet, electronic device). The input device is in wireless communications device with one or more of the display screens, either directly through a wireless network or indirectly using a wireless network and an intermediate remote server.

Direct wireless connections include, but are not limited to, short range radio frequency data transmission protocols (e.g. Bluetooth or equivalent), cellular networks (e.g. 3G, LTE, or equivalent), or wireless local area network (e.g. Wi-Fi or equivalent). Indirect wireless connections include a cellular or wireless local area network, whereby an intermediate remote server is used to coordinate commands from one or more input terminals and send signals to the one or more display screens. The remote server preferably is hosting a website or similar interface for the remote terminal to log-in and enter commands using the remote terminal. These commands include the specific content to be delivered, editing the same, and furthermore choosing which of the one or more display screens to update.

Multiple display screens may be wirelessly connected to the same input terminal, turning the input terminal into a centralized display screen modification terminal. Electronic display screens arranged throughout a dispersed area may be updated remotely and nearly simultaneously.

The ease of using the system is illustrated through the disclosure of a method of updating a digital display message. Since the system does not require a person to physically input information using his hands, the user can update messages while driving, counting inventory, or while otherwise engaged. In this manner, updated display messages and content can be displayed within seconds of a decision to update. The system and method are rapidly deployable with highly customizable placement, making it well adaptable for a variety of environments.

It is therefore an object of the present invention to provide a new and improved digital message display system that has all of the advantages of the prior art and none of the disadvantages.

It is another object of the present invention to provide a digital message display system in which one or more electronic display screens can display messages and content via commands from one or more remote input terminals.

Yet another object of the present invention is to provide a digital message display system in which displayed message or content is rapidly modifiable in real time and without physical input from a user.

A further object of the present invention is to provide a digital message display system that may be readily fabricated from materials that permit relative economy and are commensurate with durability.

Another object of the present invention is to provide a digital display system that offers a remotely accessible web interface to enable remote users to update system display screens.

Another object of the present invention is to provide a digital display system that offers direct transmission of commands to a display screen over a network using an application layer on the input terminal.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general diagram of the digital message display system of the present invention. The remote input terminal is illustrated as a smartphone for exemplary purposes.

FIG. 2 shows a general diagram of the present digital message display system in which the input device responds to various inputs from a user. The remote input terminal is illustrated as a smartphone for exemplary purposes.

FIG. 3 shows an exemplary embodiment of the remote input terminal and the application layer thereon showing several electronic display screens controllable via the remote input terminal using the application layer thereon. A list of display screens paired with the input terminal is shown to the user, who may select the screens the user wishes to update.

FIG. 4 shows an exemplary embodiment of the remote input terminal and the application layer thereon providing a text input interface. Users may use the alphanumeric keypad on the text input interface to input text for transmission over a wireless network to update an electronic display screen.

FIG. 5 shows an exemplary embodiment of the remote input terminal and the application layer thereon providing a graphic input interface in which a user can manually draw images or text on the input terminal. The input terminal in this example is a smartphone with a touchscreen; however alternative graphic input interfaces are contemplated. Users may draw on the input interface to create digital content or textual content for transmission over a wireless network to update an electronic display screen.

FIG. 6 shows an exemplary embodiment of the remote input terminal and the application layer thereon providing a graphic input interface in which a user can import and create digital content in the form of images, video, and text. The input terminal in this example is a smartphone with a touchscreen; however alternative graphic input interfaces are contemplated. Users may capture, create, or import content on the input interface to create digital content or textual content for transmission over a wireless network to update an electronic display screen.

FIG. 7 shows a schematic diagram of an exemplary implementation of the electronic display.

FIG. 8 shows a flow diagram of a method of updating an electronic display.

FIG. 9 shows another flow diagram the textual input using the alphanumeric keypad, voice-to-text entry, or the graphic input interface to create a textual message for transmission to an electronic display.

### DETAILED DESCRIPTION OF THE INVENTION

Reference is made herein to the attached drawings. Like reference numerals are used throughout the drawings to depict like or similar elements of the digital message display system. For the purposes of presenting a brief and clear description of the present invention, the preferred embodiment will be discussed as used for updating a displayed message in real-time. The figures are intended for representative purposes only and should not be considered to be limiting in any respect.

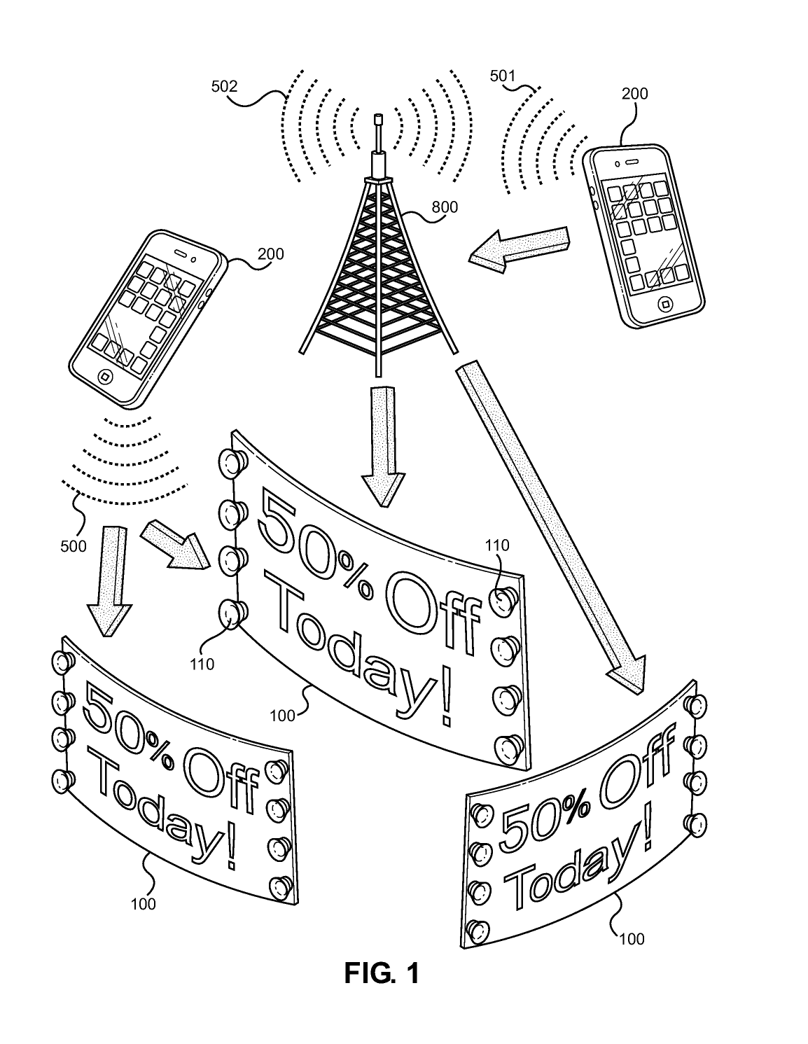

Referring now to FIG. 1, there is shown a graphical view of the implementation of the digital message display system. The system employs a configurable electronic display device 100 to display messages and content thereon. The messages and content are displayed on the display screen of the display device. The data for the messages and content for display are remotely dictated by a remote input terminal 200 that communicates with the display device 100 over one or more wireless networks. The remote input terminal 200 is shown in the drawing views as a handheld electronic device, such as a smartphone, tablet, or similar electronic device. However, the remote input terminal 200 may any handheld electronic device that is mobile and capable of a network connection, thereby allowing operation of an application layer on the go and without being tied to a static computer structure. The input terminal is therefore a handheld electronic device adapted to handle the conversion of analog input signals to digital data (i.e. physical user input into digital information on the handheld electronic device). The handheld device includes a processor, a storage, a memory, an input/output controller, a wireless communication device adapted to receive and transmit data over the wireless network, one or more inputs, a display, and a power source.

The wireless network is one of a short-range wireless network, or a long-range wireless network. A remote server may function as an intermediary between remote input terminals 200 and display devices 100, or alternatively one or more remote input terminals 200 may be in direct wireless connection with one or more display devices 100 over a wireless network. The short-range wireless networks 500 include short range radio frequency data transmission protocols (e.g. Bluetooth or equivalent) or wireless local area network (e.g. Wi-Fi or equivalent). The long-range wireless networks 501 include cellular networks (e.g. 3G, LTE, or equivalent) and potentially satellite network connections. Cellular networks function in combination with terrestrial networks and cellular networks 502, while satellite network connections are configured to operate with a geosynchronous satellite for transmission of radio signals.

Both direct and indirect data transmission between the input terminal 200 the display devices 100 is contemplated. An application layer on the input terminal is used as a graphic user interface for the user of the remote input terminal 200, whereby messages and content can be created and transmitted either directly to the display devices 100 or through an intermediate remote server (i.e. indirect data transmission). Short-range wireless networks 500 such as Bluetooth and Wi-Fi connections support direct data transmission to the display devices 100, while long-range wireless networks 501 and some Wi-Fi connections preferably employ an intermediate remote server. The input terminal 200 may run the application layer independently on the device, or alternatively may interface with an application or web site running on the remote server. Using a remote server may be preferred for batch control of multiple display devices 100, whereby a user interfaces with the remote server using the application layer on the input device 200 to log-in and send commands to one or more display devices 100. The application layer using either direct or indirect wireless connection provides for creation of content, editing of the same, and choosing which of the one or more display screens to update. Furthermore, the input terminal and the display device are in bi-directional wireless communication such that the display can communicate necessary date to the input device and vice versa.

Multiple electronic display screens may be in communication with the same input terminal. Each of the display devices 100 may include a specific pairing code such that each screen is recognized by the input terminal 200. Thus, a user can control any number of electronic screens for which they have the pairing codes. Each display screen may include a code retrieval button that results in display of the pairing code when pressed. This enables re-pairing of display screens if a connection is disrupted. This is a common method of connection using Bluetooth devices. It is further contemplated the code may be manually entered to connect the input terminal 200 to a display device 100 when direct Wi-Fi connections are used or indirect data transmission through a remote server is utilized for data transfer. Bluetooth and Wi-Fi direct connections enable the user to control the display devices 100 remotely provided they are within the Bluetooth range or Wi-Fi network range, depending on signal strength. Signal range may vary depending on the specific network employed during system implementation.

To enable updating of display screens when users are outside the operating range of direct wireless data transmission, the display device may utilize a cellular, satellite, or indirect Wi-Fi connection. Cellular connections are provided using a general packet radio service (GPRS) controller on the display devices 100, which can receive GPRS tunneling protocol (GTP) data packets via a global system for mobile communications (GSM), universal mobile telecommunications system (UMTS), or long term evolution (LTE) network, thereby enabling the system to transfer data to the display screens over a cellular data network 800. Indirect Wi-Fi connections allow the input terminal to interface with a remote server over an internet connection, whereby the display screen is wirelessly connected to the internet using a Wi-Fi connection. The remote input terminal 200 communicates with a remote server, which communicates data over the internet, over the Wi-Fi network, and to the display screen. Depending on the complexity of the display screen, the display screen may support several different wireless connections, including both direct and indirect wireless connections. Similarly, the application layer of the remote input terminal may allow switching of transmission methods to take advantage of a more stable connection based on the environment within which the remote input terminal is located (i.e. choosing direct connections, cellular, or indirect Wi-Fi connections). In this method, all front-end procedures are the same, but changes to back-end procedure will occur to facilitate transmission via the most efficient network. Over the cellular network, data is transmitted to an identification number associated with the GPRS controller of desired display devices 100.

Convenience of use may be further increased with the inclusion of a web interface hosted on a web server. One or more input terminals 200 can access the web interface hosted on the server via a network. Each input terminal 200 and server is implemented as a computing device having a system bus in communication with at least the components of: a central processor; a main memory; a storage; an input/output (I/O) controller; display devices; and a network interface (i.e. a wireless communication device including one of a short-range and/or long-range wireless network interface). An operating system and various software routines are stored on the storage memory of the remote input terminal 200. Input/output devices such as a keyboard, touchpad, touchscreen, mouse, speakers, and a microphone may be connected to the I/O controller. The addition of further components or substitution of different configurations of a component will be known to one of ordinary skill in the art and are not enumerated in detail herein.

Each of the remote servers may run an application stack comprising but not limited to web servers, file upload/download servers, associated databases, and authentication applications. The upload/download server and databases may be integrated with the web server application. Databases will retain user account information as well as display screen identifying information, to enable look up of identifier information associated with display screens and data transmission to same. A web server includes sub-applications for hosting a website and providing client-side services. Input terminals can access these services via a website hosted on said web server, pending successful login with the authentication application. Authentication may consist of password checking, credential verification, or confirmation of other identifying information. Once a user is authenticated, they can begin entering messages and transmitting to selected display screens. In this manner, the web interface may be accessed using any Internet accessible computing device.

In some embodiments, identifier information associated with a particular display device 100 may be automatically transferred to the input terminal 200 upon initial code pairing or code input into the input terminal 200. Pairing is conducted automatically when the display device is discoverable, or alternatively a pairing code may be entered for connection over direct or indirect wireless networks. This allows a user to find and control a display device without contacting the display device or being within physical proximity to one or more of the display devices. Connectivity and identifier information may be automatically uploaded to the remote server upon registration with the application on the remote server. Alternatively, the user may need to input identifier information (i.e. the cellular identification number or pairing code) manually into both the remote terminal and the remote server each time he or she desires to add new screens to the list of available display screens.

Using the direct network Bluetooth connection, new display devices can be identified using a Bluetooth lookup and filtering against the manufacturer MAC vendor block. By default devices use the final three bytes of the MAC address as hexadecimal and the name of the manufacturer prepended as a device name (Example 0F:AC:DE); this identification can be customized by the user to be more meaningful for the given display screen. A settings interface is incorporated into the client interface of the application. Users can modify display screen names (identification string) and pairing codes via the settings interface.

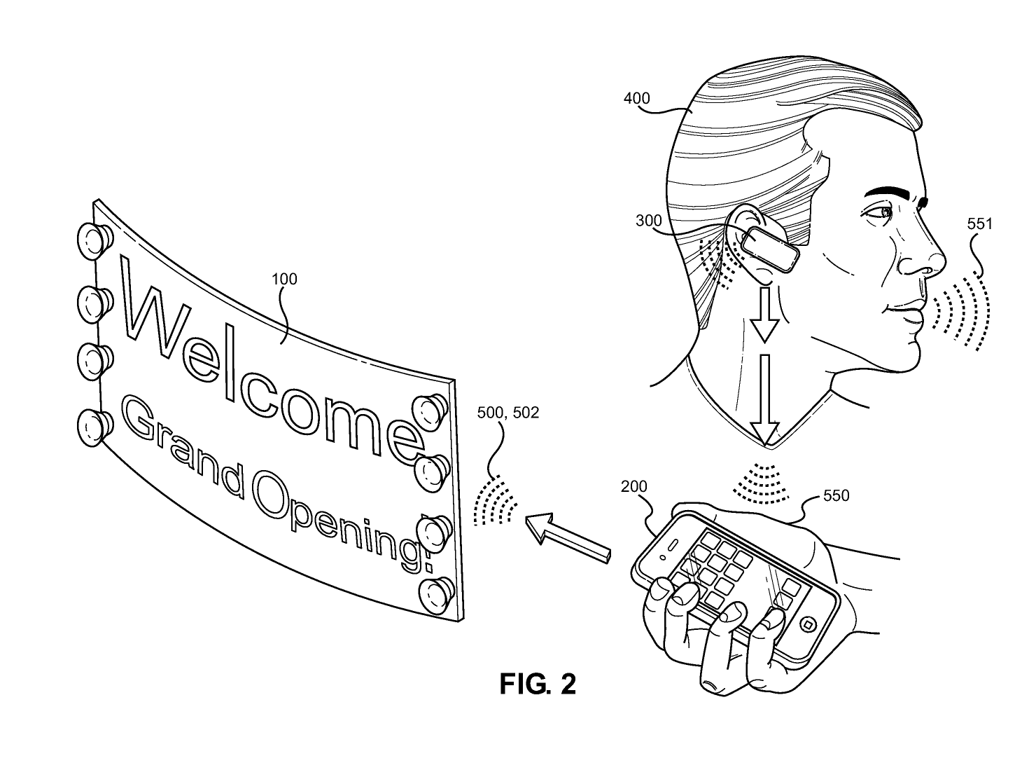

Several input methods are contemplated for creating digital content on the input terminals 200. One such method involves voice-to-text input. Each input terminal 200 using voice-to-text input utilizes installed voice recognition software to convert verbal instructions into data segments. Converted verbal input is transmitted in data packets to one or more display screens the wireless network. Bluetooth enabled microphones and headsets may also be paired to the input terminal to provide an additional means of verbal input. As shown in FIG. 2, an earpiece style Bluetooth headset 300 comprising at least a microphone, a speaker, a transceiver, a memory, a central processor, and a storage memory is paired to the input terminal smartphone 200. Verbal input 551 is captured by the headset 300 and is transmitted from the headset to the input terminal 200, which relays the data to the display device 100 over the short-range 500 or long-range 502 wireless network. This configuration enables a user 400 to modify displayed messages via a hands-free microphone. Similarly, the input terminal 200 may receive direct verbal input 551 without the intermediate headset, whereby a microphone on the input terminal 200 receives the verbal input directly.

Along with voice-to-text input, the user can make direct textual input using an alphanumeric interface on the input terminal. This may include entering text using a touchscreen and an alphanumeric keypad by hand 500 or by stylus, or alternatively drawing text on a touchscreen on the input terminal 200. The drawn text and the alphanumerically input text are converted into textual data for review prior to transmission over the given network. Additional methods of input textual data include alternative I/O devices, such as keyboards, digital graphic input interfaces (i.e. electronic drawing pads, touchscreens, etc.), or equivalent textual input devices supported by a handheld input terminal.

In addition to the aforementioned features of the input terminal devices, each remote terminal 200 includes a custom application layer protocol with a client interface to facilitate creating, reviewing, editing, and transmitting of content to different display devices 100. Exemplary embodiments of the application layer on the input terminal 200 are shown in FIGS. 3-6. FIG. 3 shows a view of the application layer displaying on the display screen of an input terminal 200 a list of discovered display devices 530. Display devices that have already been connected with the input terminal 200 offer quick selection of the desired display devices to be interfaced with at one time. The devices may be simultaneously paired or individually paired to the remote terminal depending on the wireless network chosen. Using Bluetooth connections, one display device is paired at a time. Using local Wi-Fi or control through the intermediate remote server allows for control of more than one display device at one time, and for batch transmission of data to multiple display devices.

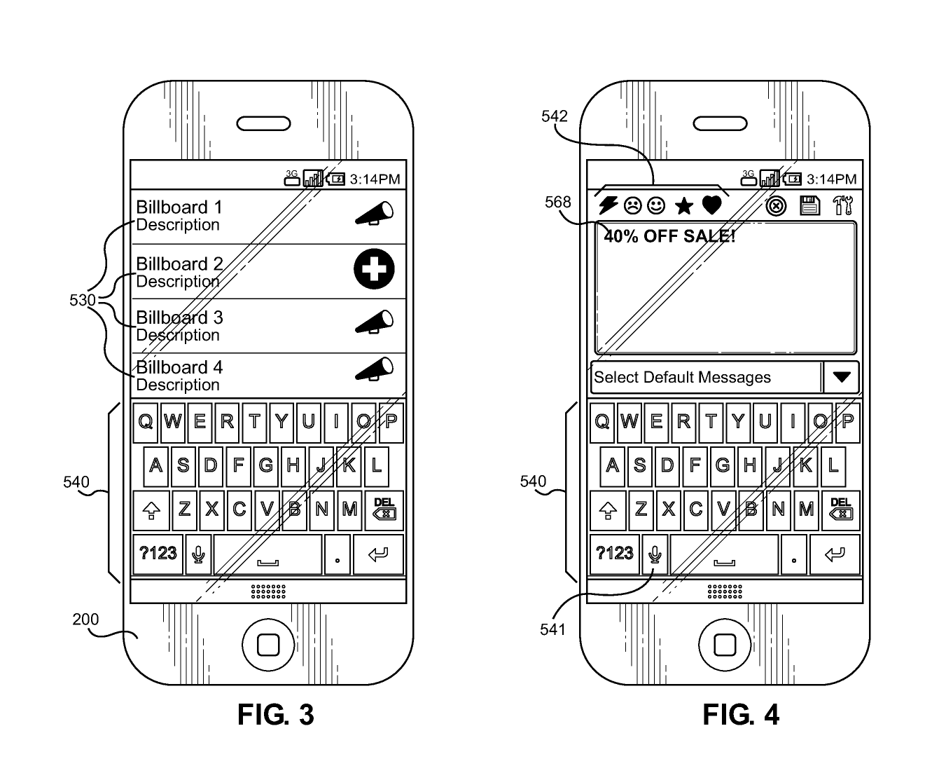

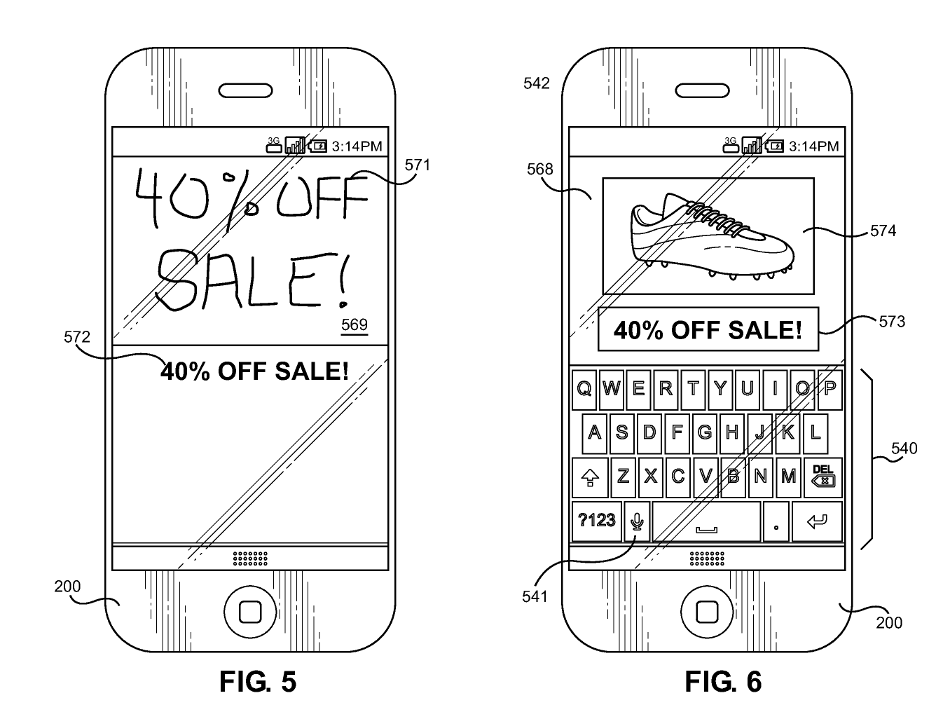

Shown on FIGS. 4 and 5 is an exemplary embodiment of the alphanumeric keypad 540 of the input terminal 200. The keypad 540 may comprise physical buttons on the input terminal 200, a touchscreen interface, or alternatively a keyboard peripheral device. The alphanumeric keypad 540 allows the user to type messages 568 to be transmitted to the display device. The user creates the message 568, edits and reviews the same, and then transmits the text to one or more of the display devices. The application layer installed on the storage of the remote input terminal is adapted to receive the alphanumeric text input from the alphanumeric keypad interface 540 and convert the user input into the digital data stored on the memory of the input terminal 200. The user can then utilize the application layer to direct the input terminal to transmit the textual data over the wireless network using the input terminal's wireless communication device and to the complimentary wireless communication device of the chosen display devices. A processor within the display devices is adapted to decompose the data from the transmitted signal and direct a display screen driver circuit to display the user textual input on the screen of the display device. Textual input includes letters, numbers, symbols 542, and the like, which can be entered manually, drawn, or input using the voice-to-text feature 541.

An exemplary alphanumeric text input interface is shown in FIG. 4. An input terminal 200 includes an application layer with a client interface. The application layer leverages the I/O functionality thereof to enable the user to enter digital visual content in the form of textual data. The user creates the textual digital visual content by entering text manually in the client interface, or by speaking a message for transcription to text using voice-to-text features on the input terminal. The text is then displayed on the screen of the input terminal for review prior to transmission. From the client interface, the user may select a speak button 541 to initiate sound recording. Once analog input is converted into digital signals and then analyzed for language patterns, the resulting text is displayed on the input terminal screen for review. Alternatively, the user may enter a message via the alphanumeric keypad 540. Various icons (happy face, heart, clover, etc.) are accessed via icon buttons 542. Completed messages may be saved as “quick messages” for later use, or may be transmitted to the display screen of a user's choosing for immediate display. It should be understood that the client interface should offer substantially the same functionality regardless of choice of input terminal (i.e. the type of handheld electronic device).

Referring to FIG. 5, there is shown a view of one examples of the drawing input interface of the remote input terminal 200. A digital graphic input interface is provided by the input terminal, comprising one of a touchscreen input, stylus input, mouse I/O device, or equivalent. The user can quickly draw a message or symbol 571 using the application layer, which provides an input area 569. The application layer (i.e. user interface) installed on the storage remote input terminal is adapted to receive the drawn user input and create digital content 572 from the user input using the digital graphic input interface. The application layer is further adapted to convert the user input into the digital data for transmission over a wireless network using the wireless communication device of the remote input terminal and to the wireless communication device of at least one electronic display. The digital content 572 is the recognized text or symbol created by the drawn input. The transmitted digital data is received by the processor of an electronic display device, which decomposes the data and directs a display screen driver circuit to display the user input on the display screen.

Referring now to FIG. 6, there is shown a view of an example of the application layer (i.e. user interface) handling digital visual content and editing the same. The input terminal can be used to create, capture, and store digital visual content in the form of images, pictures, video, drawn content, textual content, or the like. The digital content 574 is loaded and can be edited by overlaying textual content 573 thereover. The digital visual content 574, in some embodiments, comprises a photograph captured by a camera on the input terminal 200. Alternatively the photograph may be stored thereon or loaded thereonto. Furthermore, the digital visual content 574 may be hand drawn input using the digital graphic input interface as described from FIG. 5. The digital visual content 574 may also be a video captured by the input device 200 or loaded thereonto. The user edits the digital visual content 574 by overlaying text 573 using the alphanumeric keypad input 540 or the voice-to-text input 541. The application layer provides a blank template 568 upon which the content 574 and the text 573 may be loaded, arranged, edited, and created.

Turning now to FIG. 5, there is a block diagram showing exemplary display hardware architecture of the display device 100. The configuration disclosed herein is for illustrative purposes only and the invention is not limited to any particular implementation of the display device 100. The screen of the display device 100 may be a rigid or flex-printed screen depending on the intended use of the system.

In the exemplary embodiment, each display device comprises the display controller board 120 and the LED panel board 150. The display device 100 preferably operates using a battery power supply 124, but may also be charged and directly run from DC power supply via a DC input 128. Alternative embodiments are also contemplated in which the display device is directly powered using outlet power and no battery power source is utilized.

The display screen 150 is an electronic display consisting of individual LEDs 151 arranged as a matrix of rows and columns thereof. The display screen is driven by a display driver that includes a driver integrated circuit, a display interface, and a communications interface. Input is received by the display controller board 150 through the communications interface, which is then translated by the driver controller integrated circuit and output from the display interface. The signals from the display driver control the display of the LEDs 151 on the display screen. Alternative embodiments of the display screen include alternative forms of image projection or illumination. These include LEDs, LCDs, and other common displays. The exemplary embodiment described herein is but one example of the type and configuration of the display device, whereby the exemplary embodiment is provided as one example for explanatory purposes. The architecture of the screen and the display device generally provided herein is not to be construed as limited to one configuration, but rather one example of a display device falling within the claimed system of the present invention.

The display controller board 120 receives messages from the input terminal application layer via a short-range 500 or long-range 501 network connection. In a preferred configuration, each display controller board 120 includes a Bluetooth radio interface 122 and/or a GPRS cellular network interface 129. An internal process 970 processes and validates the messages received and controls the display driver over an internal serial communication bus. A power supply 124 and battery charger 125 on the controller board conditions the external 12 VDC power to generate the necessary voltages and signals required to power the microcontroller, Bluetooth module, and GPRS module, and to charge the internal battery 124. The controller board 120 is implemented on a printed circuit board within the display device 100.

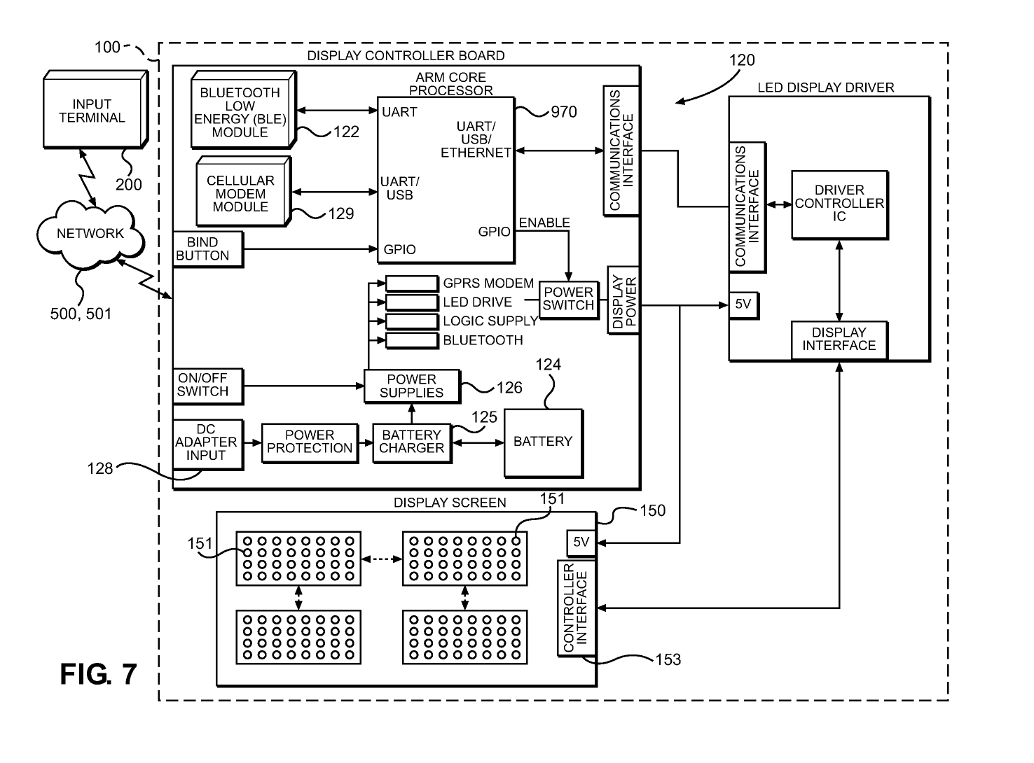

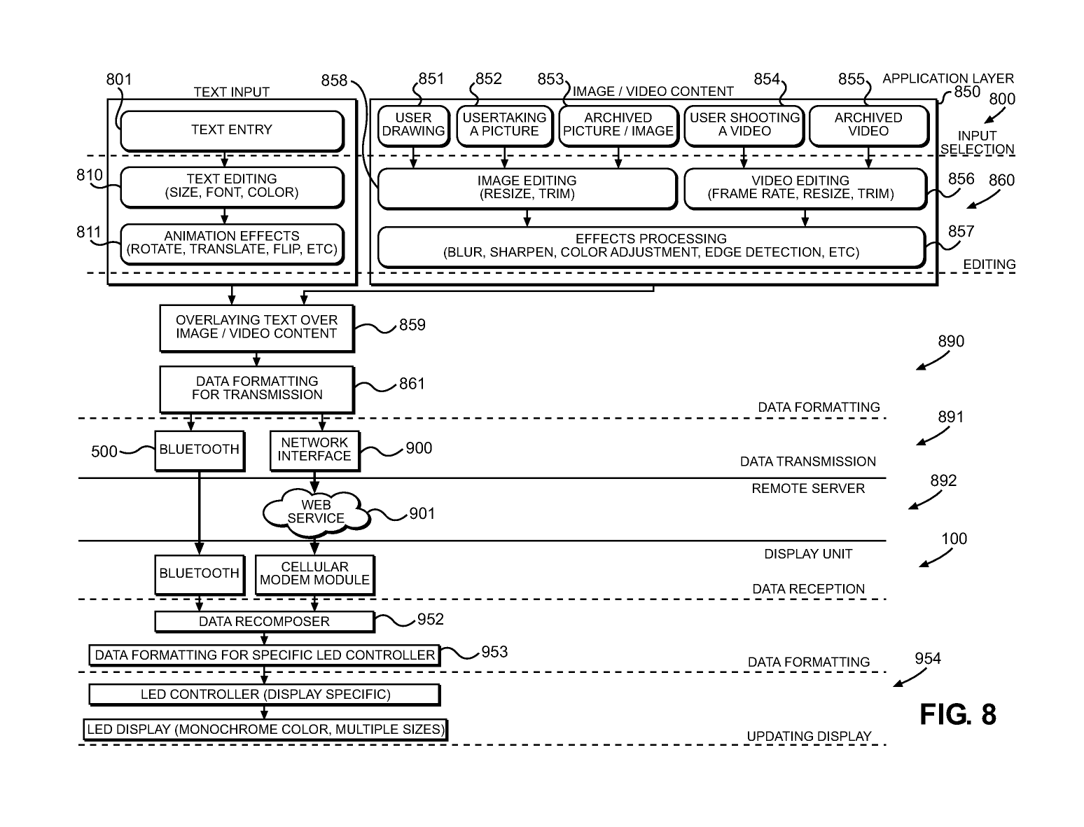

The main control functions of the electronic display screen are preferably implemented in a programmable processor 971 with integrated memory. The 120 controller is preferably well suited for battery-powered applications and is energy efficient. Other low energy MCUs may also be used in the manufacture of the display. An I2C like serial interface interfaces the controller to the battery charger for future monitoring if required. The interface to the Bluetooth module is implemented using an UART interface, while the interface to the display drivers consists of an SPI like serial interface implemented in software and hardware GPIO pins. Each of the display drivers also has a chip select pin implemented using GPIO. The wireless Bluetooth interface has an internal antenna that has an RF path to the outside of the enclosure in order to communicate properly with the input terminal. The exact configuration shown in FIG. 7 and described herein is but one example configuration of the display device 100. Alternate architectures and electrical layouts are contemplated.

The wireless cellular modem module 129 has a connector that enables connection to an external or internally placed antenna. The selection of an internal versus an external antenna may be decided based on manufacturing needs. It should be noted that the cellular model module 129 may comprise a GPRS module, but this is an exemplary example and modules of alternate standards may be implemented to take advantage of second, third, fourth and higher generations of wireless technology.

In one embodiment, the display device has a depressible pairing button that causes a pairing code associated with the screen to be displayed thereon. This functionality facilitates retrieval of lost or forgotten pairing codes. The pairing button may also facilitate automatic connection to the input terminal 200 over the short-range, Bluetooth network.

In some embodiments, the electronic display screen will have a plurality of suction cups secured to portions of its outer perimeter. Further, magnetic strips may be attached to the rear of the electronic display screen. Thus, the screen can be removably secured to a window using the suction cups, or the side of a vehicle using the magnetic strips. These features function particularly well in embodiments of the system employing flexible display screens.

Flow diagrams of the use of the system are shown in FIGS. 7 & 8. FIG. 7 shows the flow of creating content, editing the same, and then transmitting the content to the display device over the network. The first step is input selection 800, in which the user chooses the type of content and the method of inputting the content into the input terminal. This includes textual input 801 using the several methods mentioned above, or digital content 850 in the form of images, drawings, video, or the like. Digital content is captured, created, or loaded onto the input terminal. This includes user drawings 851, picture capture 852 using a camera on the input terminal, and video capture 854 using the motion picture camera on the input terminal. Images 853 and video 855 can also be loaded onto the input terminal and retrieved when creating the desired content to be transmitted to the display device.

Once the input is selected 800, the input can be edited 860 using the application layer on the input device. This includes editing text 810 or giving the text animated effects 811. This also includes editing images 858 and video 856, and furthermore applying visual effects 857 to the images and video. Text can furthermore be overlaid 859 onto the digital content once both text and the digital content are created/loaded and edited. Once editing 860 is completed, the data is formatted for transmission 861 using the input terminal. The data is then either directly transmitted over a direct network connection or indirectly transmitted via a remote server 901. A direct connection 500 includes a Bluetooth connection or local wireless network, while indirect networks access a remote server 901 via a network interface (i.e. a wireless communication device). The display device receives the transmitted signal directly or indirectly from the input terminal. The data is received using a Bluetooth module, Wi-Fi antenna, satellite phone antenna, or cellular modem. Once received, the signal is decomposed 952 to retrieve the digital data transferred in the signal. The data is formatted 953 using the display controller board of the display device and the display is updated 954.

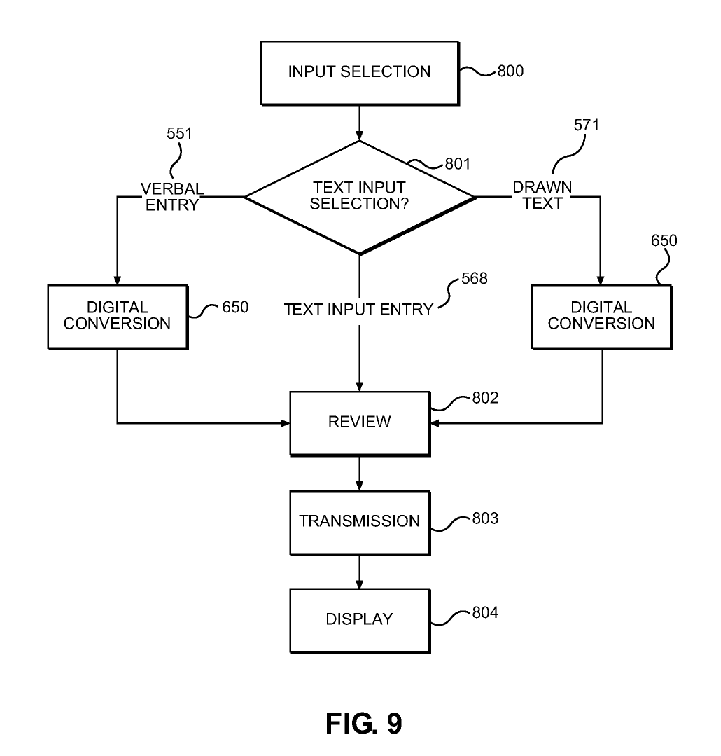

Referring to FIG. 9, there is shown a diagram further outlining the input selection 800 when text 801 is chosen. The method of entering text includes direct text entry using an I/O device (e.g. a keyboard, an alphanumeric keypad, etc.), drawn input 571, and verbal input 551. Drawn and verbal input, along with the direct text entry is converted 650 to text for review 802. The text can be verified for accuracy prior to be transmitted 803 from the input terminal and subsequently displayed 804 on the display device.

The present invention is a system and associated method of use for updating a digital display via a wireless communications device. Users can turn their smartphone, tablet computer, or equivalent handheld electronic device into an input terminal by installing a software application that installs the application layer necessary to operate the device as an input terminal within the present system. Any number of Bluetooth, Wi-Fi, or GPRS enabled electronic display devices may be paired with the input terminal device. Display devices may also be registered with a remote server or directly with the input terminal, and access to the remote server is provided over a website using an associated user account. The screens can therefore be updated using one or more remote terminals, updating either directly or indirectly the content of the display devices.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A digital message display system, comprising:
a wireless network;
at least one remote input terminal comprising a processor adapted to handle conversion of analog input to a digital data, a storage, a memory, an input/output controller, a wireless communication device adapted to receive and transmit data over the wireless network, an text input interface, a display, and a power source;
wherein the at least one remote input terminal comprises at least one handheld electronic device;
at least one electronic display comprising a display screen, a processor, a power source, a display screen driver circuit, and a wireless communication device for transmitting and receiving signals over the wireless network;
wherein said wireless communication device of said least one electronic display is in bi-directional wireless communication with the wireless communication device of said least one remote input terminal;
an application layer installed on said storage of said at least one remote input terminal, wherein said application layer is adapted to receive user textual input from the text input interface and convert the user textual input into the digital data for transmission over the wireless network using the wireless communication device of the remote input terminal, wherein the processor of the at least one electronic display is adapted to decompose the digital data and direct the display screen driver circuit to display the user input on the display screen.

2. The digital message display system of claim 1, wherein the wireless network comprises a Bluetooth wireless network.

3. The digital message display system of claim 1, wherein the wireless network comprises a wireless local area network.

4. The digital message display system of claim 1, wherein the wireless network comprises a cellular network.

5. The digital message display system of claim 1, wherein:
at least one remote server adapted to receive the digital data transmitted from the wireless communication device of the remote input terminal and transmit the digital data to the wireless communication device of the at least one electronic displays.

6. The digital message display system of claim 1, wherein the text input interface further comprises an alphanumeric keypad.

7. The digital message display system of claim 1, wherein the text input interface further comprises a microphone and voice-to-text software on the remote input terminal.

8. The digital message display system of claim 1, wherein the text input interface further comprises a graphic input interface adapted to receive digitally drawn input, whereby the application layer is further adapted to convert the digitally drawn input into the digital data

9. A digital message display system, comprising:
a wireless network;
at least one remote input terminal, comprising a processor adapted to handle conversion of analog input to a digital data, a storage, a memory, an input/output controller, a wireless communication device adapted to receive and transmit data over the wireless network, a display, and a power source;
wherein the at least one remote input terminal comprises at least one handheld electronic device;
at least one electronic display comprising a display screen, a processor, a transceiver, a power source, and a wireless communication device for transmitting and receiving signals over the wireless network;
wherein said wireless communication device of said least one electronic display is in bi-directional wireless communication with the wireless communication device of said least one remote input terminal;
an application layer installed on said storage of said at least one remote input terminal, wherein said application layer is adapted to receive and store digital visual content on the storage of the at least one remote input terminal and then transmit the digital visual content from the at least one remote input terminal over the wireless network using the wireless communication device of the remote input terminal, wherein the processor of the at least one electronic display is adapted to decompose the digital visual content and direct the display screen driver circuit to display the digital visual content on the display screen.

10. The digital message display system of claim 9, wherein the wireless network comprises a Bluetooth wireless network.

11. The digital message display system of claim 9, wherein the wireless network comprises a wireless local area network.

12. The digital message display system of claim 9, wherein the wireless network comprises a cellular network.

13. The digital message display system of claim 9, wherein:
at least one remote server adapted to receive the digital data transmitted from the wireless communication device of the remote input terminal and transmit the digital data to the wireless communication device of the at least one electronic displays.

14. The digital message display system of claim 9, wherein the at least one remote input terminals further comprise at least one personal computer.

15. The digital message display system of claim 9, wherein the digital visual content comprises one of textual data, digital drawings, photographs, or motion pictures.

16. The digital message display system of claim 9, wherein the at least one remote input terminal further comprises a camera for capturing photographic digital visual content.

17. The digital message display system of claim 9, wherein the at least one remote input terminal further comprises a video camera for capturing video digital visual content.

18. A method of displaying content on a display device, comprising the steps of:
receiving input using an application layer on a handheld electronic device;
converting the input into digital visual content;
formatting the digital visual content into data suitable for transmission over a wireless network;
establishing wireless communication between the handheld electronic device and a display device;
transmitting the data to the display device;
decomposing the data into the digital visual content on the display device;
displaying the digital visual content on the display device.

19. A method of displaying content on a display device, comprising the steps of:
receiving input using an application layer on a handheld electronic device;
converting the input into digital visual content;
formatting the digital visual content into data suitable for transmission over a wireless network;
establishing wireless communication between the handheld electronic device and a remote server;
receiving a selection of one or more display devices to transfer the data;
transmitting the data to the selected display devices using the remote server;
decomposing the data into the digital visual content on the display device;
displaying the digital visual content on the display device.
